(19) United States
(12) Patent Application Publication
(10) Pub. No.: US 2010/0219020 A1
(43) Pub. Date: Sep. 2, 2010

(54) Pressure accumulator tank system for applying a substance

(75) Inventor: Michael L. Knox, McDonald, TN (US)

Correspondence Address: IPLM GROUP, P.A., POST OFFICE BOX 18455, MINNEAPOLIS, MN, 55418, US

(73) Assignee: Ecolab Inc.

(21) Appl. No.: 12/394,640

(22) Filed: Feb. 27, 2009

(51) Int. Cl. F16N 27/00; F01M 1/18; F16N 13/16; E03B 5/00

(52) U.S. Cl. 184/7.4; 184/108; 184/29; 137/565.17

(57) ABSTRACT

A pressure accumulator tank system for applying a substance and a method of applying substance are provided. The pressure accumulator tank system of an embodiment includes a main distribution line, a main pump, a pressure switch and at least one feeding line. The main pump is configured to pump the substance into the main distribution line. The pressure switch is located in the main distribution line and is configured to control operation of the main pump to maintain a select pressure in the main distribution line. Each feeding line includes a feeding conduit, a pressure accumulator and a manifold. The feeding conduit is coupled to the main distribution line to receive the substance in the main distribution line. The pressure accumulator is coupled to provide a select pressure in the feeding conduit. The manifold has an inlet and at least one outlet. The inlet of the manifold is coupled to the feeding conduit. Each outlet is configured to output the substance to a distribution zone.

### BACKGROUND

Conveyer systems in commercial packing or packing operations require lubrication to ensure products pass through the conveyer systems as desired. Typically two types of lubrications are used. The first type is a concentrated lubricant that is diluted with water to form an aqueous lubricant solution. Although this type of lubrication system permits high-speed operation of conveyer systems, it requires a large amount of water. The large amount of water can cause an unduly wet environment which may not be desirable in a given operation. The second type of lubrication is called a dry lube. Dry lubes historically have referred to a lubricant composition with less than 50% water that is applied without dilution. Hence, large amounts of water are not needed to apply the lubricant. However, without the relatively low viscosity provided by the added water, applying the dry lube could be an issue.

For the reasons stated above and for other reasons stated below which will become apparent to those skilled in the art upon reading and understanding the present specification, there is a need in the art for an effective and efficient method of applying dry lube.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a pressure accumulator tank system for applying a substance is provided. The pressure accumulator tank system includes a main distribution line, a main pump, a pressure switch and at least one feeding line. The main pump is configured to pump the substance into the main distribution line. The pressure switch is located in the main distribution line and is configured to control operation of the main pump to maintain a select pressure in the main distribution line. Each feeding line includes a feeding conduit, a pressure accumulator and a manifold. The feeding conduit is coupled to the main distribution line to receive the substance in the main distribution line. The pressure accumulator is coupled to provide a select pressure in the feeding conduit. The manifold has an inlet and at least one outlet. The inlet of the manifold is coupled to the feeding conduit. Each outlet is configured to output the substance to a distribution zone.

### BRIEF DESCRIPTION OF THE DRAWINGS

The present invention can be more easily understood and further advantages and uses thereof more readily apparent, when considered in view of the detailed description and the following figures in which:

FIG. 1 is a block diagram of a lubrication system of one embodiment of the present invention;

FIG. 2 is a block diagram of a feeding line of a lubrication system of one embodiment of the present invention;

FIG. 3 is lube system flow diagram of one embodiment of the present invention;

FIG. 4 is an alarm flow diagram of one embodiment of the present invention; and

FIG. 5 a zone dispensing flow diagram of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide an effective and cost efficient lubrication system. Further benefits of embodiments include, but are not limited to, not requiring conduit and wiring from each production line to the lube pump location and not requiring an individual lube line from the pump to discharge headers. In embodiments the system pressure is stored at the point of usage and does not rely on the lube pump to deliver pressure and a volume of lube. This helps prevent inconsistent pressures and volumes due to the distance between a pump and the points of usage. Another advantage of the present invention is that multiple pumps are not required.

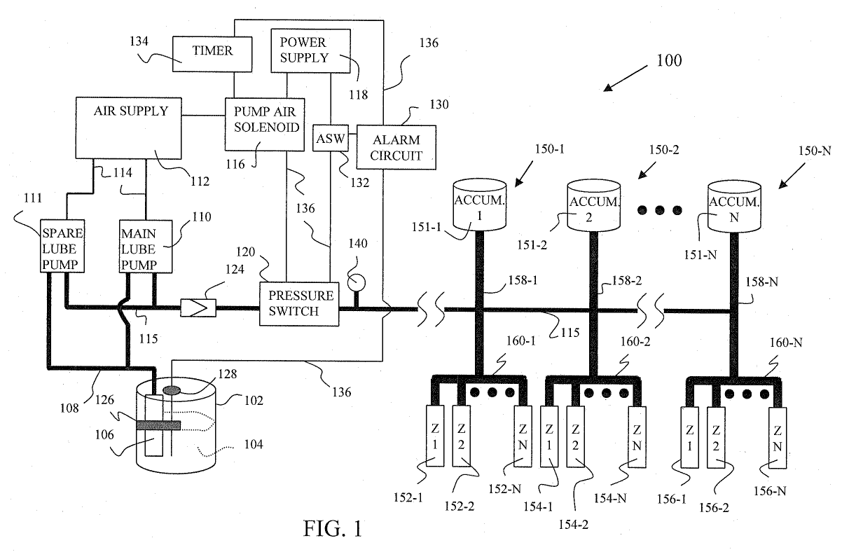

Referring to FIG. 1, an exemplary embodiment of a lubrication system 100 is provided. As FIG. 1 illustrates, the lubrication system 100 includes dry lube 104 that, in this example, is contained in a drum 102. A main lube pump 110 is in fluid communication with the dry lube 104 in the drum 102 via pick up line 108 and pick up 106. In one embodiment a spare lube pump 111 is used if the main lube pump 110 fails. The spare lube pump 111 is in fluid communication with the dry lube 104 also via pick up line 108 and pick up 106. The main lube pump 110 and the spare lube pump 111 are generally referred to as pump 110 and pump 111 hereinafter. Pump 110, or pump 111 if needed, pumps lube 104 from the drum 102 via pick up 106 and pick up line 108 into a main lube line 115. In the embodiment of FIG. 1, pumps 110 and 111 are pneumatic pumps run by air supply 112. A check valve 124 in the main line 115 is used to keep pressure off of the pump 110 or 111 when the pump 110 and 111 is not pumping. This prevents a back pressure from pushing lube through the pump's 110 or 111 diaphragm (not shown). Moreover, the check valve 124 ensures that when the pump 110 or 111 is activated that no pressure will be on the pump 110 or 111. This prevents the pump 110 or 111 from locking up. Also illustrated in FIG. 1 is a pressure gauge 140 that provides an indication of the pressure in the main lube line 115.

As discussed above, the pumps 110 and 111 are run by air supply 112. The air supply 112 is operated with an activation circuit that includes a power supply 118, a pump air solenoid 116 and a pressure switch 120. As illustrated, the pump air solenoid 116 activates the air supply 112 when the pressure switch 120 is closed. In operation, the pressure switch 120, in this embodiment, is a normally closed switch that opens at a select pressure. For example, the pressure switch 120 may open when the pressure in the main lube line 115 reaches 40 PSI and remains open until the pressure in the main line 115 goes below 35 PSI. Hence, in this example, the pump 110 or 111 is shut off once the pressure in the main line 115 reaches 40 PSI and then is started again when the pressure in the main line 115 lowers to 35 PSI. An example of a switch that could be used in embodiments is switch model number FSG2121CP made by the Square D manufacture, which has an operating range of 30-50 PSI.

The embodiment of FIG. 1 also includes an alarm circuit 130 that is used to shut down the lube pumps 110 and 111 if a problem exists. The alarm circuit 130 operates alarm switch 132 which opens to prevent the activation circuit from operating the pumps 110 and 111. In this embodiment, the alarm circuit 103 is coupled to receive a low lube indicator signal from a low lube level circuit 128. In this embodiment, the low level circuit 128 uses a float 126 attached to the pick up 106 in the barrel 102 to indicate if the level of lube 104 is low. This alarm prevents air from being pumped into pump 110 or 111. If air inadvertently enters the pick up line 108 and enters the pump 110 or 111, the pump 110 or 111 will have to be re-primed before it can be used. Hence, the low level circuit 128 prevents the pump 110 or 111 from having to be re-primed because of lack of lube 104. The alarm circuit 130 in this embodiment is also connected to a timer circuit 134 that tracks the amount of time the lube pump 110 or 111 is running. If the lube pump 110 or 111 is running for a period of time that is longer than an anticipated period of time, the alarm circuit 130 opens the alarm switch 132 thereby stopping the lube pump 110 or 111. The lube pump 110 or 111 running longer than anticipated can indicate a leak in the lubrication system 100. In one embodiment, the alarm switch 132 has to be manually closed to reset the alarm system once the problem has been corrected.

As illustrated, the lubrication system 100 includes the main distribution line 115 and feeding lines 150-1 through 150-N. The feeding lines 150-1 through 150-N, provide a path for the lube 102 to respective zones 152, 154 and 156. The zones 152, 154 and 156 are points of distribution of the lubrication by means known in the art. In the example of FIG. 1, feeding line 150-1 includes zones 152-1 through 152-N, feeding line 150-2 includes zones 154-1 through 154-N and feeding line 150-N includes zones 156-1 through 156-N. As further illustrated in FIG. 1, each feeding line 150-1 through 150-N includes its own pressure accumulator 151-1 through 151-N. In particular, feeding line 150-1 includes pressure accumulator 151-1, feeding line 150-2 includes pressure accumulator 151-2 and feeding line 150-N includes pressure accumulator 151 -N. The pressure accumulators 151 -1 though 151 -N (hereinafter collectively referred to as pressure accumulators 151) store pressure at the usage point thereby not requiring the receipt of pressure from a pump at a central location. The pressure accumulators 151 are coupled to a respective manifold 160 via conduit 158. In particular, accumulator 151 -1 is coupled to manifold 160-1 via conduit 158-1, accumulator 151-2 is coupled to manifold 160-2 via conduit 158-2 and accumulator 151-N is coupled to manifold 160-N via conduit 158-N. Embodiments can be used to retrofit existing lubrication systems. For example, referring to FIG. 1, a system that was originally designed to transmit wet lube that included a main line 115 and feeding conduits 158-1 through 158-N can be retrofit with a dry lube delivery system as discussed above with the use of pressure accumulators 151-1 through 151-N on the respective feeding conduits 158-1 through 158-N. Hence, embodiments are not limited to new installations.

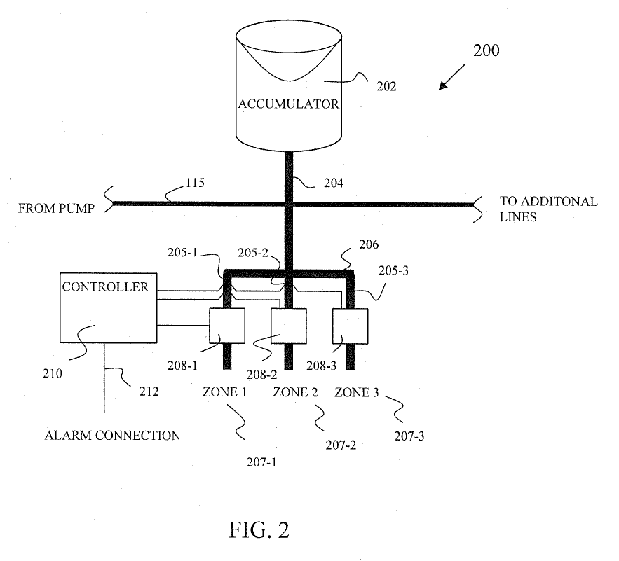

Referring to FIG. 2 an example of a feeding line 200 of an embodiment is illustrated in detail. As illustrated, the pressure accumulator 202 is coupled to a manifold 206 via feeding conduit 204. Feeding conduit 204 receives the lube from the main lube line 115 as illustrated. The manifold 206 provides passages 205-1, 205-2 and 205-3 to associated zones 207-1, 107-2 and 207-3. Although, three zones 207-1 through 207-3 are illustrated, the number of zones used will vary as dictated by the application. Hence the present application is not limited to the number of zones or the number of feeding lines. As illustrated in FIG. 2, solenoid valves 208-1, 208-2 and 208-3 are positioned between the manifold 206 and each zone 207-1, 207-2 and 207-3. In particular, solenoid valve 208-1 is positioned between the manifold 206 and zone 207-1, solenoid valve 208-2 is positioned between manifold 206 and zone 207-2 and solenoid valve 208-3 is positioned between manifold 206 and zone 207-3. The solenoid valves 208-1, 208-2 and 208-3 are used to regulate the flow of lube 104 to the zones 207-1, 207-2 and 207-3. The solenoid valves 208-1 through 208-3 are controlled by a controller 210. The controller 210 controls the respective solenoid valves 208-1, 208-2 or 208-3 based on the lube requirement of a particular zone 207-1, 207-2 or 207-3. In particular, the controller 210 controls the frequency of the activation of the solenoid valves 208-1, 208-2 and 208-3 (hereinafter collectively referred to as solenoid valves 208) as well as the duration that the solenoid valves 208 are open to obtain a desired coefficient of drag. The frequency and duration is based on the lube requirement for a particular zone 207-1, 207-2 and 207-3. Each zone 207-1 through 207-3 may require its own unique frequency and duration of operation. In one embodiment the controller 210 is a mechanical device incorporating timers such as Ecolab's Dry Exx controller. In another embodiment, the controller 210 is a programmable logic controller. Further in one embodiment, the controller 210 has a communication connection 212 to the alarm circuit 130. In this embodiment, the controller 210 closes the solenoid valves 208 when an alarm circuit signal indicating a problem with the lube system 100 has been received from the alarm circuit 130. This effectively shuts down the entire lube system 100 when a problem occurs.

In one embodiment, the pressure accumulator 202 is a 2 gallon pressure well tank pre-charged to a pressure of 21 PSI. An example of such a pressure well tank is made by WaterWorker having a model number of HT-2. This type of pressure accumulator is desirable because it has a low probability of failure. This is due to the fact that it will be used in ambient temperatures with no condensation which is unlike the conditions it was made to handle in well tank applications. Moreover, silicon based lubrication is likely to extend the life of a bladder in the presser well tank. In one embodiment, a larger diameter feeding line 204 is used than the diameter of the main lube line 115. This minimizes a pressure drop to each zone over great distances. In one embodiment, a ¾ inch pipe is used for the feeding conduit 204 and a ½ pipe is used for the main lube line 115 (or main distribution line 115). Further in one embodiment, PVC pipes are used for the feeding conduit 204 and the main distribution line 115.

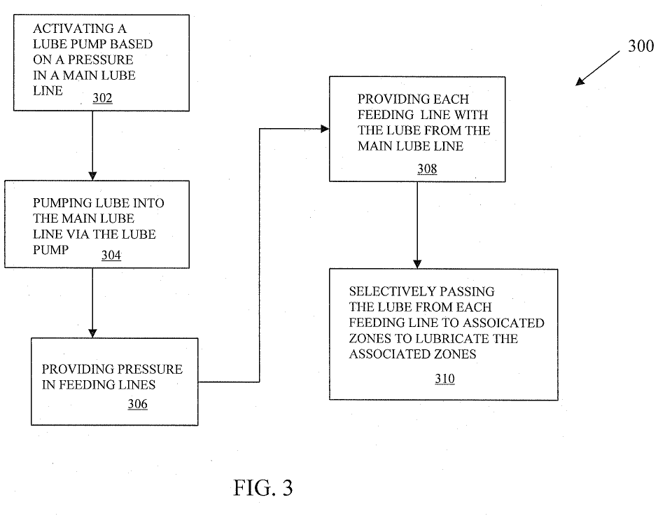

FIG. 3 illustrates a lube system flow diagram 300 of an embodiment. As illustrated, the process starts by activating a lube pump based on a pressure in a main lube line (302). The pump then pumps lube out of a lube container into the main lube line (304). In the meantime, pressure is provided in feeding lines (306). Each feeding line, in one embodiment, receives pressure from an associated pressure accumulator. Each feeding line is provided lube from the main lube line (308). The lube in each feeding line is selectively passed to an associated zone to lubricate the associated zones (310).

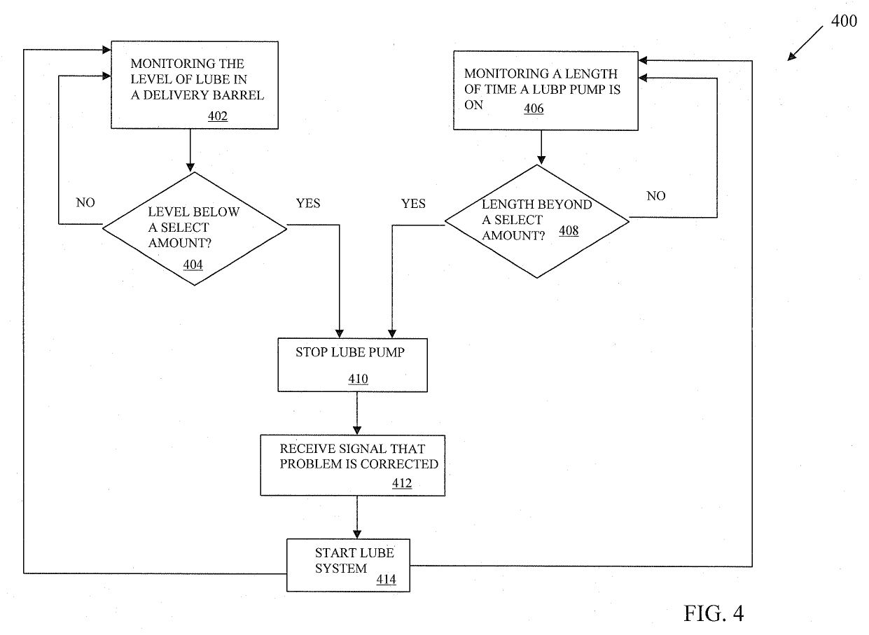

Referring to FIG. 4, an alarm flow diagram of one embodiment is illustrated. In this embodiment, the level of lube in a delivery container is monitored (402). It is determined if the level is below a select level (404). If the level of lube is not below the select level (404), the level is continued to be monitored at (402). If the level is below the select level (404), the pump is stopped (410). The pump will remain stopped until a signal is received that indicates a new container of lube has replaced the empty container (412). Once that occurs, the lube system is re-started (414) and the level of lube is again monitored at (402). As the flow diagram also illustrates, the length of time the lube pump is running is also monitored (406). It is determined if the length is beyond a predetermined length of time (408). If the pump does not run longer than a select length of time (408), the running time of the pump is continued to be monitored at (406). If the pump runs longer than the select length of time (408), the lube pump is stopped (410). The pump will remain stopped until it receives a signal that a problem in the system has been corrected (412). Once that occurs, the lube system is re-started at (414) and the length of time the pump is running is again monitored at 406.

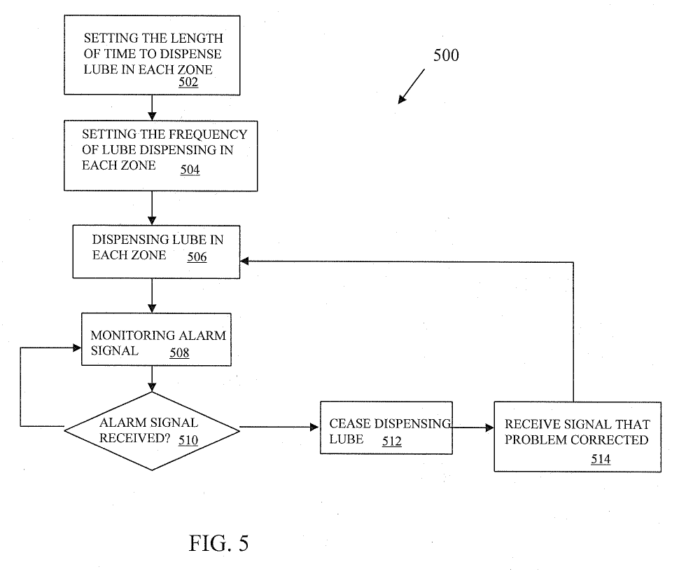

A zone dispensing flow diagram 500 of one embodiment is illustrated in FIG. 5. As illustrated this process starts by setting the length of time to dispense lube in each zone (502) and setting the frequency of lube dispensing in each zone (504). As discussed above, the dispensing length and frequency will depend on the specific application required in a zone. For example, in a conveyer system it may be desired to obtain certain coefficient of drag so that products such as bottles will travel on the conveyer as desired. Determining the select coefficient of drag and what duration and frequency achieves the select duration can be obtained by testing or by formulas as know in the art. Once the duration and frequency is known for each zone, the lube is dispensed accordingly (506). In one embodiment, the controller that controls the dispensing of the lube to the zones monitors an alarm controller for an alarm signal that would indicate a problem with the lube system (508). When no signal is detected (510), the system continues monitoring (508). When a signal is detected (510), the dispensing of lube to the zones is stopped (512). Once a signal is received that the problem is corrected (514), the system continues dispensing lube at (506).

Some embodiments of the alarm circuit 103 of FIG. 1 and the programmable logic controller 210 of FIG. 2 incorporate a processor and memory to store instructions in implementing steps set out in the flow diagrams of FIGS. 4 and 5. A processor includes or functions with software programs, firmware or computer readable instructions for carrying out various methods, process tasks, calculations, and control functions. These instructions are typically tangibly embodied on any appropriate medium used for storage of computer readable instructions or data structures. Such computer readable media can be any available media that can be accessed by a general purpose or special purpose computer or processor, or any programmable logic device. Suitable computer readable media may include storage or memory media such as magnetic or optical media, e.g., disk or CD-ROM, volatile or non-volatile media such as RAM (e.g. SDRAM, DDR SDRAM, RDRAM, SRAM, etc.), ROM, EEPROM, flash memory, etc.

Although specific embodiments have been illustrated and described herein, it will be appreciated by those of ordinary skill in the art that any arrangement, which is calculated to achieve the same purpose, may be substituted for the specific embodiment shown. For example, the above description relates to the delivery of lube to provide lubrication to a system. However, the present invention contemplates the use of embodiments for applying other substances such as but not limited to chemical agents and pesticides. Accordingly, this application is intended to cover any adaptations or variations of the present invention. Therefore, it is manifestly intended that this invention be limited only by the claims and the equivalents thereof.

1. A pressure accumulator tank system for applying a substance comprising:
a main distribution line;
a main pump configured to pump the substance into the main distribution line;
a pressure switch in the main distribution line, the pressure switch configured to control operation of the main pump to maintain a select pressure in the main distribution line; and
at least one feeding line, each feeding line including,
a feeding conduit coupled to the main distribution line to receive the substance in the main distribution line,
a pressure accumulator coupled to provide a select pressure in the feeding conduit, and
a manifold having an inlet and at least one outlet, the inlet of the manifold coupled to the feeding conduit, each outlet configured to output the substance to a distribution zone.

2. The system of claim 1, further comprising:
a check valve in the main distribution line configured to prevent back pressure from reaching the main pump.

3. The system of claim 1, further comprising:
a spare pump configured to replace the main pump if the main pump fails.

4. The system of claim 1, further including:
a pick up configured to remove the substance from a container that is to be supplied to the main pump.

5. The system of claim 1, wherein the main pump is a pneumatic pump.

6. The system of claim 5, further comprising:
an air supply coupled to output an air flow to run the main pump;
a pump air solenoid coupled to the pressure switch, the pump air solenoid further coupled to control the air supply; and
a power supply coupled to provide power to the pump air solenoid when the pressure switch is closed.

7. The system of claim 1, wherein the substance is a substance selected from the group consisting of lube, cleaning chemicals and pesticides.

8. The system of claim 1, further comprising:
an alarm circuit configured to shut down the main pump if a problem exists.

9. The system of claim 8, further comprising:
a low substance detecting device configured to send a low substance signal to the alarm signal when the substance supply is running low.

10. The system of claim 8, further comprising:
a timer circuit configured to track the amount of time the main pump is running and send a signal to the alarm circuit when the pump has run longer than a predetermined period of time.

11. The system of claim 1, further comprising:
a valve for each output of the manifold, each valve configured to regulate a flow of lube out of the manifold to an associated zone; and
at lease one controller coupled to control each valve.

12. The system of claim 1, wherein the feeding conduit of the at least one feeding line has a larger diameter than a diameter of the main distribution line.

13. A lubrication pressure accumulator tank system comprising:
a main line;
a pump coupled to pump dry lube into the main line;
a pressure switch coupled to regulate the operation of the pump to maintain a desired pressure in the main line; and
a plurality of feeding lines, each feeding line having a feeding conduit coupled to the main line to receive the lube, each feeding line further having a pressure accumulator coupled to provide a select pressure in an associated feeding conduit, each feeding line further yet having a manifold with an input coupled to the feeding conduit and at least one output to output the lube at a zone of distribution.

14. The system of claim 13, further comprising:
an alarm circuit coupled to shut off the pump if a problem exits.

15. The system of claim 13, further comprising;
a valve for each output of the manifold, each valve configured to regulate a flow of lube out of the manifold to an associated zone; and
at lease one controller coupled to control each valve.

16. The system of claim 15, wherein the controller is configured to close all values if an alarm signal is received.

17. The system of claim 13, wherein the pump is a pneumatic pump, the system further comprising;
an air supply coupled to output an air supply to run the pump;
a pump air solenoid coupled to the pressure switch, the pump air solenoid further coupled to control the air supply; and
a power supply coupled to provide power to the pump air solenoid when the pressure switch is closed.

18. The system of claim 13, wherein the system is retrofit.

19. A method of dispensing a substance, the method comprising:
pumping substance into a main distribution line;
maintaining a select pressure in the main distribution line;
providing pressure in at least one feeding line coupled to the main distribution line with at least one pressure accumulator; and
dispensing the substance to at least one select zone through an manifold coupled to the at least one feeding line.

20. The method of claim 19, further comprising:
monitoring the level of substance in a supply container; and
when the level of substance in the supply container is low, stopping the pumping of substance in the main distribution line.

21. The method of claim 19, further comprising
monitoring the length of time a pump is on pumping the substance into the main distribution line; and
when the time the pump is on is more than a select time, stopping the pumping of substance in the main distribution line.

22. The method of claim 19, further comprising:
setting a length of time to dispense the substance in each zone; and
setting the frequency to dispense the substance in each zone.

23. The method of claim 22, further comprising:
dispensing the substance in each zone based on the set length of time and frequency.
